(19) United States
(12) Patent Application Publication
(10) Pub. No.: US 2011/0081448 A1
(43) Pub. Date: Apr. 7, 2011

(54) PROCESS FOR TREATING VANILLA BEANS

(75) Inventors: J. Patrick Dunphy, Wellingborough (GB); Richard J. Middleton, Northants (GB); Ian Butler, Northants (GB); Ingmar Qvist, Northampton (GB); Krishna Bala, St. Louis, MO (US)

(73) Assignee: Firmenich SA

(21) Appl. No.: 12/951,932

(22) Filed: Nov. 22, 2010

Related U.S. Application Data
(63) Continuation of application No. 11/320,315, filed on Dec. 29, 2005.
(60) Provisional application No. 60/641,154, filed on Jan. 5, 2005.

(51) Int. Cl. A23L 1/221

(52) U.S. Cl. 426/44

(57) ABSTRACT

There is provided a process for the preparation of cured vanilla bean pieces comprising steps of: i) blanching vanilla beans; ii) optionally cooling the blanched vanilla beans of step i); iii) comminuting the blanched vanilla beans of steps i) or ii); iv) incubating the comminuted pieces of step iii); and v) drying the incubated pieces of step iv).

### FIELD OF THE INVENTION

This invention relates to a process for curing vanilla beans, a method of monitoring the level of vanillin during such a process, to vanilla bean pieces cured according to such a process, and to vanilla extract prepared from vanilla bean pieces cured by such a process.

### BACKGROUND

Vanilla is a flavouring prepared from the seed-pods of various orchids of the genus vanilla. Ripe green vanilla beans have virtually no flavour or odour. These are typically allowed to develop during a process known as curing. The characteristic flavour and aroma of vanilla is due to the presence of vanillin, vanillic acid, para-hydroxybenzoic acid and para-hydroxybenzoic aldehyde, amongst others.

Although vanilla beans will eventually cure if left on the vine, the process has been subject to improvements with the aim of reducing the length of time taken to obtain the cured product.

In the Mexican process, green beans are harvested, placed on blankets and exposed to the direct rays of the sun for about an hour. They are then placed in blanket-lined cases where they are allowed to “sweat” for twenty-four to forty-eight hours. The sweating process is repeated a number of times after which time the beans are allowed to cool and age until cured.

In the Bourbon process, the beans are initially blanched in hot water. They are then placed in blanket-lined cases where they are allowed to “sweat” for twenty-four to forty-eight hours. The sweating process is repeated a number of times after which time the beans are allowed to cool and age until cured.

Both processes are followed by drying, conditioning, extraction of the cured vanilla, and optional concentration.

Both the Mexican and the Bourbon process take a long time to complete, with three to four months being typical. Moreover, the vanilla produced is not of uniformly high quality.

### PRIOR ART

U.S. Pat. No. 2,621,127 discloses a method of dehydrating and curing vanilla beans which comprises grinding the green beans to a thick, fluid-like pulp. Air is then passed through the pulp, which is held at a temperature of 49-55° C. (120-130° F.), with simultaneous agitation. The pulp is subsequently spread onto trays, which are place in a dehydrator. When the moisture content of the pulp is lowered to about 20%, the beans are ground to a finer form suitable for extraction.

U.S. Pat. No. 2,835,591 discloses a method of producing cured vanilla extract from green vanilla beans comprising chopping the beans in an oxygen free atmosphere and performing several extractions with water to obtain green bean extract. The extract is then concentrated. One or more enzyme systems are then added to the concentrate, which catalyse the conversion to cured vanilla extract.

U.S. Pat. No. 3,663,238 discloses a process for drying and curing vanilla beans wherein the ripe green vanilla beans are chopped into short lengths. The chopped beans are placed in trays, and the trays are stacked several deep in curing tanks. The tanks are held at 60° C. for 70 to 78 hours. The bean pieces are then dried. A two-stage drying process comprising an initial drying with heated, forced air at 60° C. until the beans reach 35-40% moisture, followed by drying in air at ambient temperature until a moisture content of 20-25% is reached.

U.S. Pat. No. 4,956,192 discloses a process for obtaining vanilla flavour comprising freezing green vanilla beans. The frozen beans are warmed to between 20 to 60° C., upon which the characteristic vanilla flavour and aroma begins to develop.

A problem that still remains is to provide a process for the curing of green vanilla beans which reduces the overall length of treatment.

A further problem is to provide cured vanilla beans having a high content of flavour components, in particular vanillin.

The present invention addresses/alleviates problems of the prior art.

### SUMMARY OF THE INVENTION

According to a first aspect of the present invention there is provided a process for the preparation of cured vanilla bean pieces comprising steps of:

i) blanching vanilla beans;
ii) optionally cooling the blanched vanilla beans of step i);
iii) comminuting the blanched vanilla beans of steps i) or ii);
iv) incubating the comminuted beans of step iii);
v) drying the incubated pieces of step iv).

According to a first aspect of the present invention there is provided vanilla bean pieces obtainable by a process as defined herein.

According to a second aspect of the present invention there is provided vanilla bean pieces prepared by a process as defined herein.

According to a third aspect of the present invention there is provided vanilla extract obtainable by a process as defined herein.

According to a fourth aspect of the present invention there is provided vanilla extract prepared by a process as defined herein.

### BRIEF DESCRIPTION OF THE FIGURES

FIG. 1 shows glucovanillin and vanillin content during incubation of ripe green vanilla beans at 51° C. in the presence and absence of air.

### DETAILED DESCRIPTION

By the term “blanching” it is meant a process of heat treatment. This may be achieved by various means, including heating in air, treatment with steam or immersion in water. Preferably, blanching occurs at a temperature in excess of 50° C., such as greater than 60° C., greater than 70° C., greater than 80° C., or greater than 90° C.

Vanilla beans suitable for treatment in the process of the invention are those which are green or have not attained their full potential of flavour and aroma. Preferably, the vanilla beans are harvested and then subjected to the process of the invention; some pre-treatment steps (such as washing) may be included. Optimally, vanilla beans used in the process are ripe (i.e. have developed a maximum level of glucovanillin) and/or green (i.e. have not yet started to cure on the plant and/or physically are green but starting to show signs of yellowing or browning at one or both tips of the bean.).

For ease of reference these and further aspects of the present invention are now discussed under appropriate section headings. However, the teachings under each section are not necessarily limited to each particular section.

### Blanching

The first step in the process according to the present invention is to blanch ripe, green vanilla beans. The blanching step is conducted at a sufficient temperature and for a sufficient length of time to kill fungal organisms and other pathogens detrimental to the subsequent steps, but not for sufficient time to negatively affect the enzyme systems that are essential to the incubation (fermentation) of the beans.

Preferably, blanching is conducted in water. Preferably, blanching is conducted at between 40 and 100° C. More preferably, blanching is conducted at between 50 and 80° C. Still more preferably, blanching is conducted at between 60 and 70° C. Still more preferably, blanching is conducted at between, 60 and 65° C.

In a particularly preferred embodiment, the blanching step is conducted at between 60 and 65° C. for between two and three minutes.

### Cooling

Subsequent to the blanching step, the blanched beans are preferably cooled. The cooling may be achieved by any suitable means. For example the cooling may be achieved by allowing the beans to rest at ambient temperature in air. Preferably, the beans are cooled by plunging into water. This may be preferably performed immediately after the blanching step. Preferably, the water is at or below ambient temperature. Still more preferably, the water is between 12 and 15° C.

### Comminuting

After the blanching and optional cooling step, the beans are comminuted. Comminuting serves to disturb the cell structure of the plant material, causing the wound response to be initiated. During this wound response, enzymes are released that catalyse the conversion of compounds present in the beans to the compounds responsible for the characteristic qualities of vanilla in terms of flavour and aroma.

It will be appreciated that the term “comminuting” or “comminuted” or “comminute” includes any manner for breaking one or more vanilla beans into smaller fragments. This term includes for example chopping. Any suitable apparatus may be used for comminuting the beans. A bowl chopper has been found to be particularly convenient.

Any degree of comminuting is acceptable provided that it serves to elicit the wound response. Preferably, the beans are comminuted or chopped into longitudinal pieces (i.e. comminuted or chopped perpendicular to the length of the bean). More preferably, the beans are comminuted into pieces wherein the average size is between 0.1 and 5 cm in length. Still more preferably, the beans are comminuted into pieces wherein the average size is between 0.3 and 2 cm in length.

Most preferably, the beans are comminuted into pieces wherein the average size is between 0.5 and 1 cm in length. Surprisingly, it has been found that when the beans are comminuted into pieces of this size, optimal results are achieved in subsequent steps. Without wishing to be limited by any such theory, it is proposed that bean pieces of this size have the optimum surface area exposed to air/the atmosphere. Finer comminuting or chopping tends to result in a pulp through which atmosphere cannot circulate, while larger pieces have a lower surface area to weight ratio. Additionally, small pieces tend to exude liquor containing enzymes and flavour component precursors, which it is desirable to retain.

### Incubation

Following comminuting, the bean pieces are incubated. By “incubation” it is meant that the process by which the compounds characteristic of vanilla are allowed to develop. This step is also referred to as fermentation, although microbes are not believed to be involved.

Many suitable incubation techniques are known to those skilled in the art. The bean pieces may for instance be placed in traditional blanket lined boxes. They may be sealed in containers substantially impermeable to water vapour. Alternatively, they may be placed in perforated trays, and said trays stacked in a suitable curing tank. The incubation process is then allowed to proceed at an appropriate temperature, which the skilled man will be able to determine.

In one preferred aspect the incubation is performed at a temperature of 30 to 55° C.

The progress of the incubation process is preferably monitored so that the content of the desired aroma components is optimised. In particular, it has been found advantageous to monitor the ratio of vanillin to its precursor, glucovanillin. High performance liquid chromatography (HPLC) is useful in this regard. Additionally, the content of the products formed by the breakdown of vanillin (mainly coloured polyphenols) may be monitored. Colourimetry is useful is this regard.

By monitoring the levels of vanillin, its precursor and metabolites, one skilled in the art will be able to judge when the incubation process is complete, and so conclude it.

Optionally, one or more enzyme systems may be added to the comminuted bean pieces at any time before or during the incubation step. By way of example, pectinolytic, diastatic, proteolytic, glycosidic and catalase enzymes, in different amounts and combinations, may be added.

In one aspect of the invention, the bean pieces are placed in shallow layers on beds or trays in order to incubate. A bed can be any surface suitable for supporting such a layer of beans. Any tray may be used, provided it allows for circulation of air throughout the layer of bean pieces. For example, a perforated tray may be used, provided the perforations are sufficiently small so as not to permit bean pieces to fall through.

In a particularly preferred embodiment, the vanilla bean pieces are incubated at about 30° C. and 70% relative humidity.

Preferably, a moving tray or bed may be used. For instance, the bed may be a conveyor belt. The use of such a moving bed or tray is advantageous in that it allows the incubation step to be carried out in a continuous fashion under controlled conditions of temperature and humidity. Alternatively, drum incubation may be employed, whereby the comminuted beans are constantly rotated to achieve maximum aeration and uniformity.

Preferably, the temperature of the beans is maintained at 20 to 60° C. More preferably, the temperature is maintained at between 30 and 50° C.

Preferably, the relative humidity of the atmosphere is between 50 and 100%. More preferably, the relative humidity is 60 to 80%. Most preferably, the relative humidity is 65 to 75%.

The relative humidity can be controlled by any means that will be well known to those skilled in the art. It has been found preferable to maintain the humidity of the atmosphere by periodic misting of the layer of beans with water.

Preferably, the layer of beans is mixed during the incubation process, for instance by incubation in a rotating drum. The mixing may be achieved by any suitable means, as will be apparent to one skilled in the art. The mixing assists in bringing the enzymes into contact with the glucovanillin, and so speeds the process.

### Anaerobic Incubation

In a highly preferred embodiment, the incubation process comprises at least an anaerobic step.

As used herein, the term “anaerobic step” refers to a process step which is conducted under an atmosphere having a reduced content of oxygen compared with atmospheric air.

Preferably, the anaerobic step is conducted under ah atmosphere with an oxygen content of less than 20% oxygen. More preferably, the anaerobic step is conducted under an atmosphere with an oxygen content of less than 15% oxygen. More preferably, the anaerobic step is conducted under an atmosphere with an oxygen content of less than 10% oxygen. More preferably, the anaerobic step is conducted under an atmosphere with an oxygen content of less than 5% oxygen. More preferably, the anaerobic step is conducted under an atmosphere with an oxygen content of less than 1% oxygen. More preferably, the anaerobic step is conducted under an atmosphere with an oxygen content of less than 0.1% oxygen. Most preferably, the anaerobic step is conducted under a substantially oxygen free atmosphere.

Surprisingly, it has been found that under these conditions predominantly hydrolytic conversion of glucovanillin to vanillin occurs without the formation of brown pigments.

Preferably, the anaerobic step is conducted for between 48 and 72 hours.

Preferably, the anaerobic step is conducted at a temperature of between 45 to 60° C.

In a preferred embodiment, incubation is curtailed after the anaerobic step, and the vanilla bean pieces are optionally dried and extracted as hereinafter described. This embodiment of the invention provides enhanced levels of vanillin suitable for extraction and use in flavouring and perfumery applications.

Preferably, after anaerobic fermentation, the bean pieces are dried as described herein. More preferably, after anaerobic fermentation, the bean pieces are dried to 25 to 30% moisture by weight.

In an alternative preferred embodiment, incubation comprises an anaerobic step and an aerobic step.

As used herein, the term “aerobic step” refers to a process step which is conducted under an atmosphere having an oxygen content greater than that used in the anaerobic step.

Preferably, the aerobic step occurs under an atmosphere of air.

Preferably, the anaerobic incubation step is allowed to proceed until about 85% of the glucovanillin present in the bean pieces has been converted to vanillin. Again, the amount of these components present may be determined using methods known to one skilled in the art.

Preferably, subsequent to the anaerobic step, the aerobic step is initiated. Preferably, this is achieved by the introduction of air into the incubation vessel.

The separation of enzymatic glucoside hydrolysis (anaerobic step) from the oxygen dependent oxidoreductase browning (aerobic) step allows optimisation of the formation of vanillin, together with control of the extent of the browning reaction and the profile of the flavour and aroma components thereby produced.

### Drying

After the incubation step, the beans are dried. Many suitable drying techniques are known. Immediately after the incubation step, the bean pieces have a moisture content of 75 to 83%. The drying step reduces this to approximately 25 to 35%. Preferred drying methods include fluid bed or vibro-fluid bed drying, preferably with control of inlet and exhaust temperatures.

Preferably, the drying process takes place in a ventilated oven with a circulating airflow at 30 to 100° C. More preferably, the drying occurs at 40 to 60° C. Most preferably, the drying occurs at about 50° C.

The dried, cured vanilla bean pieces thus produced are in a form suitable for use. Alternatively, the vanilla beans can be converted to vanilla extract by any known extraction technique. The three main extraction techniques currently employed are the percolation method, the oleoresin method and extraction with liquid carbon dioxide.

### Extraction

The percolation method consists of circulating a mixture of ethanol to water in the ratio between 35:50 to 50:50 (v/v) through the beans under vacuum. This process takes between 48 and 72 hours.

The oleoresin method consists of pulverising the beans and circulating ethanol over the beans under vacuum at about 45° C. The excess alcohol is removed by evaporation. This process takes about 8 to 9 days.

Extraction with liquid carbon dioxide involves contacting the bean pieces with liquid carbon dioxide in an extraction vessel. The liquid extracts solute from the bean pieces, and is then transferred to a separate vessel, where the pressure is reduced. This precipitates dissolved flavour and aroma components, as the carbon dioxide returns to its gaseous state to be repressurised and recycled.

The present invention will now be described in further detail in the following examples.

### EXAMPLES

### Example 1

Ripe green vanilla beans, 3 kg, of 83.5% moisture by weight from Papua New Guinea were blanched in water at 60-65° C. for 2 min then plunged rapidly into water at 12-15° C. to rapidly reduce the temperature to ambient. This served to inhibit microbial growth in the subsequent fermentation step and to initiate the wound response reaction of the tissue. The beans were then comminuted in a bowl chopper, for a period of 30 seconds, to produce pieces of length 0.5-1.0 cm. The comminuted beans were then subjected to a fermentation process operating at 30° C. and a relative humidity of 70% in a incubation chamber for 48 hours. During this period they changed from green to a dark chocolate colour after 6 hours. At the end of the fermentation process the beans had achieved a maximum content of ca. 50 mMoles of vanillin/100 g dry weight and the hydrolysis of 90% of the starting glucovanillin precursor. The moisture content at the end of the incubation period was 72.6% by weight. Extension of the incubation period resulted in some decline in the level of vanillin on a dry weight basis.

The fermented material was dried in an air circulating oven at 50° C. for approximately 1.5 hours to a moisture content of 25% by weight. At the end of this period the vanillin content was 46 mMoles/100 g dry weight of tissue. This corresponded to a vanillin content in the dried material of 7.0 g/100 g dry weight of beans.

### Example 2

Ripe vanilla beans, 3 kg, of Indian origin and a moisture content of 83.4% by weight were blanched and comminuted as in Example 1. Fermentation was also operated under the same conditions of temperature and relative humidity, but for the shorter incubation period of 24 hours when a maximum vanillin content of 13.47 mMoles/100 g dry weight was realised. A 69% conversion of the precursor glucovanillin to vanillin was achieved during the fermentation period, with a final moisture content of the beans of 80.2% by weight. Extension of the incubation period resulted in some decline in the content of vanillin on a dry weight basis.

The fermented material was dried in an air circulating oven at 50° C. for approximately 2 hours to a moisture content of 25% by weight. At the end of this period the vanillin content was 13 mMoles/100 g dry weight of tissue. This corresponded to a vanillin content in the dried material of 2.0 g/100 g dry weight of beans.

In Example 2 both the starting level of glucovanillin and the activity of the vanilla glucoside hydrolysing enzyme(s) were lower and decreased respectively relative to the situation in example 1.

### Example 3

Ripe vanilla beans, 3 kg, of Papua New Guinea origin and a moisture content of 83.5% by weight were blanched and comminuted as in Example 1. The comminuted beans were then subjected to a fermentation process operating at 45° C. and a relative humidity of 60% in an incubation chamber for 40 hours. During this period they changed from green to a dark chocolate colour after 4 hours. At the end of the fermentation process the beans had achieved a maximum content of ca. 43 mMoles of vanillin/100 g dry weight and the hydrolysis of 90% of the starting glucovanillin precursor. The moisture content at the end of the incubation period was 68% by weight. Extension of the incubation period resulted in some decline in the level of vanillin on a dry weight basis.

The fermented material was dried in an air circulating oven at 50° C. for approx. 1.0 hour to a moisture content of 25% by weight. At the end of this period the vanillin content was 41 mMoles/100 g dry weight of tissue. This corresponded to a vanillin content in the dried material of 6.2 g/100 g dry weight of beans.

### Example 4

A laboratory scale example of a controlled two stage, anaerobic then aerobic fermentation compared to a reaction fermented only under aerobic conditions.

Ripe green vanilla beans, of Ugandan origin, 0.52 kg were placed and held in water at 60°-65° C. for 2 min then cooled by placing in 15° C. water to cool and dried in paper towels.

The blanched beans were cut with scissors into ca. 1 cm pieces then blended in a Kenwood FP520 series 700 Watt kitchen blender set at speed 2 for 20 sec resulting in pieces of average diameter 0.5 cm. Small scale incubation experiments were conducted in an Axyos Environmental Chamber fitted with a Munters MG50 Humidifier/De-humidifier system. Temperature and chamber humidity was controlled and monitored using a Eurotherm micro-digital control system. Vanilla beans were placed in trays or beakers depending on quantities with depth limits of 5-8 cm. Incubation conditions were set at 51° C. and 80% relative humidity. To assist in maintaining the high humidity value trays of water were placed in the incubation chamber. Two experimental sets of conditions were employed:
Aerobic: 232 g of blanched beans were placed in a 2 litre beaker, depth of material ca. 4.5 cm and covered with aluminium foil then incubated under the described conditions;
Anaerobic: 262 g of the blanched beans were placed in a 600 ml beaker, depth of tissue mass ca. 9 cm, which was immediately placed in a 3.5 litre capacity anaerobic incubator. To the container was added a sachet of AnaeroGen™, 3.5 litre, which scavenges oxygen along with an anaerobic indicator (BR0055B), supplied by Oxoid, UK. The lid was sealed and the anaerobic device was placed in the incubator vessel at 51° C.

The experiment was run for 72 hr under these conditions sampling both the aerobic and anaerobic materials at t=ca. 28 and 72 hr. After 72 hr the anaerobic sample was exposed to ambient air and both incubation samples kept for a further 26 hr. Analysis of colour (527 nm), glucovanillin, vanillin and moisture content was conducted.

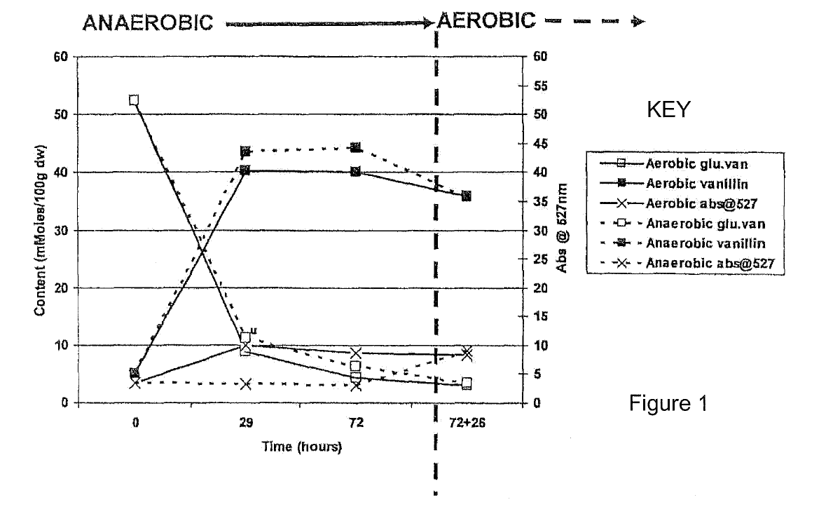

Comparison of glucovanillin and vanillin levels and % conversion of glucovanillin to vanillin in the anaerobic versus aerobic incubations (see tables 1 and 2 and FIG. 1) indicated that under oxygen deficient conditions the % conversion of the precursor glucovanillin to vanillin was not influenced; in fact based on the data the conversion anaerobically was slightly higher than in the presence of air.

This situation prevailed up to an incubation time of 72 hr. In the same time period the colour indices (normalised absorbance @ 527 nm) of the samples showed dependency on the presence or absence of oxygen. Anaerobically, from t=0 to t=72 hr the colour index did not change though the visual colour of the comminuted material did change slightly from green/yellow to a more dull green colour. Under the same temperature/time span the aerobic sample increased in colour index by 2.7 fold whilst the visual colour changed from green/yellow at t=0 to dark chocolate brown at t=72 hr.

Inspection of the aerobic sample data at t=29 hr showed a 2.9 fold increase in colour index relative to the t=0 sample a figure that did not change significantly even to the end of the experiment, a total period of 98 hr. Indeed, visual inspection of the colour of the aerobically incubated sample after 4 hr confirmed that it had changed from the initial green/yellow colour to brown.

Aroma assessment of both 72 hr samples by a flavourist described the anaerobic sample as smoky, creamy, medicinal and balsamic whilst the aerobic sample had initially a vegetable note followed by a slightly less creamy and smoky but otherwise similar character as the anaerobic sample.

At t=72 hr the anaerobic sample was exposed to air at 51° C. for a further 26 hr along with the aerobic sample under the same conditions. This introduction of air into the anaerobic sample had a number of significant consequences. The appearance of the anaerobic sample changed from dull green to dark brown. In addition the colour index increased rapidly by a factor of 2.9 relative to the colour index at t=72 hr. It is of interest that in a 26 hour period the anaerobic sample after exposure to air realised a colour index similar to the value observed in the aerobic sample after the first 29 hour period. Of greater significance was the change in the % yield of vanillin based on conversion of glucovanillin.

At 29, 72 and 98 hr for the air incubated sample the % vanillin yield based on glucovanillin consumed was 80.6, 72.9 and 62.4 whilst the figures for the % conversion of glucovanillin to vanillin were 83.0, 91.0 and 94.1 respectively. Thus although the % conversion of glucovanillin to vanillin was relatively high up to 94.1% at t=98 hr the % vanillin yield based on glucovanillin consumed fell rapidly from 80.6 (@29 hr) through 72.9 (@72 hr) to a final figure of 62.4 (@98 hr).

Comparison of the figures with the corresponding anaerobic data revealed comparable % conversion of glucovanillin to vanillin based on glucovanillin consumed but the % vanillin yield based on vanillin formed from consumed glucovanillin exhibited much higher yields for the anaerobic treatment with values of 93.3 (@29 hr) and 84.9 (@72 hr). This corresponded to a significantly higher yield of vanillin under anaerobic conditions.

Introduction of air into the anaerobic sample at t=72 hr followed by a 26 hr air incubation decreased the % vanillin yield to 62.5 a value significantly lower than the 72 hr figure and now comparable to the value observed at t=98 hr for the aerobic sample. Similar inspection of the summed data for glucovanillin plus vanillin (mMoles/100 g d.w.) shows for the aerobic sample t=0 to t=72 hr 57.6 to 44.5; the corresponding values for the anaerobic samples were 57.7 to 50.6. Further drop in this number occurred in the aerobic sample after another 26 hr incubation to 39.0. Exposure of the 72 hr anaerobic sample to aerobic conditions for 26 hr decreased the sum of the glucovanillin and vanillin contents to 39.2. This latter figure is of the same order as the aerobic sample incubated for a total of 98 hrs. It is very suggestive from these results that although the conversion of glucovanillin is not significantly affected by ±air the yield of vanillin is changed under aerobic conditions relative to anaerobic conditions. Switching anaerobic to aerobic conditions initiated a large decrease in % vanillin yield comparable to that observed in the aerobic sample.

It is clear from the above experimental data sets that:
Glucovanillin conversion is not significantly influenced by ±air conditions under the temperature/time conditions employed
Browning of ripe green vanilla beans is dependent on the presence of O₂
In the absence of air vanillin yield is maximised
In the presence of air losses of vanillin occur over time
In the absence of air vanillin losses are diminished
When air is introduced into anaerobically generated high vanillin rapid loss of the phenol occurs

These results confirm that there are two principal and separable processes in operation during incubation of vanilla beans. The first is an O₂ independent conversion of glucovanillin to vanillin. Under these condition of anaerobiosis yields of vanillin as high as 6.74 wt. % on a dry weight basis were realised and based on a % conversion of glucovanillin of 91%. Subsequent loss of vanillin formed via hydrolysis of the glucoside occurs at least in part by an O₂ dependent process that probably converts vanillin and other suitably functionalised phenols into brown pigments via the reaction of appropriate O₂ dependent oxido-reductases. These observations provide an opportunity for the segregation of vanillin formation and retention from brown pigment and probably taste generation. This may be achieved by the initial imposition of anaerobic conditions followed by the controlled introduction of air to achieve controlled brown pigment, probable taste, compound formation.

TABLE 1
Glucovanillin, vanillin and colour data from anaerobic and aerobic
incubation of ripe green vanilla beans

| | Glucovanillin | | | | Vanillin | | | |
|---|---|---|---|---|---|---|---|---|
| | g/100 | g/100 g | mMoles/100 g | Abs | g/100 g | g/100 g | mMoles/100 g | |
| Sample¹ | g fw | dw | dw | 527² | fw | dw | dw | Σ³ |
| Ripe beans | 3.48 | 16.47 | 52.45 | 3.38 | 0.16 | 0.77 | 5.06 | 57.6 |
| t28.30 − O₂ | 0.75 | 3.52 | 11.21 | 3.30 | 1.35 | 6.62 | 43.49 | 54.7 |
| t29 + O₂ | 0.60 | 2.77 | 8.82 | 9.97 | 1.33 | 6.12 | 40.21 | 49.0 |
| t72 − O₂ | 0.42 | 1.97 | 6.27 | 3.05 | 1.43 | 6.74 | 44.28 | 50.6 |
| t72 + O₂ | 0.30 | 1.38 | 4.39 | 8.66 | 1.34 | 6.10 | 40.08 | 44.5 |
| t72 − O₂ + 26 | 0.24 | 1.09 | 3.47 | 9.08 | 1.22 | 5.43 | 35.68 | 39.2 |
| air | | | | | | | | |
| t72 + O₂ + 26 | 0.22 | 0.97 | 3.09 | 8.34 | 1.22 | 5.46 | 35.87 | 39.0 |
| air | | | | | | | | |

¹Incubation time (t) in hours in the presence or absence of O₂
²Abs 527 calculated as abs value measured/100 g dw beans in 200 ml solvent
³Σ = sum of mMoles vanillin + mMoles glucovanillin/100 g dw

Experimental conditions. The anaerobic environment was first fully established, as measured by pink colour formation in an aerobic indicator paper 3 hr 15 min. after placing the tissue in the sampling jar. Following subsequent sampling of the anaerobic beans, at 29 hrs, the incubator was flushed with nitrogen gas before resealing; this treatment in conjunction with addition of a new active AnaeroGen™ pouch resulted in anaerobic conditions after only 1 hr. Visual colour inspection was carried out at all stages of sampling.

TABLE 2
Vanillin yields and % conversion of glucovanillin
to vanillin during anaerobic and aerobic
incubation of ripe green vanilla beans

| | | | | % vanillin | % |
|---|---|---|---|---|---|
| | VG | | Vanillin | yield | conver- |
| | consumed | Abs | formed | on VG | sion |
| Sample | (mMoles)¹ | 527² | (mMoles)³ | consumed⁴ | of VG⁵ |
| Ripe beans | 0 | 3.4 | (5.06) | | |
| t28.30 − O₂ | 41.24 | 3.3 | 38.43 | 93.2 | 78.6 |
| t29 + O₂ | 43.63 | 10.0 | 35.15 | 80.6 | 83.0 |
| t72 − O₂ | 46.18 | 3.1 | 39.22 | 84.9 | 88.0 |
| t72 + O₂ | 48.06 | 8.7 | 35.02 | 72.9 | 91.0 |
| t72 − O₂ + 26 | 48.98 | 9.1 | 30.62 | 62.5 | 93.4 |
| air | | | | | |
| t72 + O₂ + 26 | 49.36 | 8.3 | 30.81 | 62.4 | 94.1 |
| air | | | | | |

¹Glucovanillin at t = 0 − glucovanillin at time t
²Abs 527 calculated as abs value measured/100 g dw beans in 200 ml solvent
³Vanillin at time t − vanillin content at t = 0
⁴% vanillin yield = vanillin formed × 100/glucovanillin consumed
⁵% conversion of glucovanillin = glucovanillin at t = 0 − glucovanillin at time t/100

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

What is claimed is:

1. A process for the preparation of cured vanilla bean pieces comprising the steps of:
i) blanching vanilla beans;
ii) optionally cooling the blanched vanilla beans of step i);
iii) comminuting the blanched vanilla beans of steps i) or ii) into pieces having average size between 0.5 and 1 cm in length to facilitate further processing;
iv) incubating the comminuted beans of step iii) under conditions that include an anaerobic treatment to facilitate enzymatic glucoside hydrolysis and optimise production of vanillin; and
v) drying the incubated pieces of step iv).

2. A process according to claim 1, wherein the blanching step i) takes place in water between 60 and 65° C.

3. A process according to claim 1, wherein the vanilla beans are blanched in step i) for between 2 and 3 minutes.

4. A process according to claim 1, wherein step ii) is present.

5. A process according to claim 4, wherein the beans are cooled by treatment with water at between 12 and 15° C.

6. A process according to claim 1, wherein the incubation step iv) further comprises an aerobic step to separately provide oxidoreductase browning.

7. A process according to claim 6, wherein the aerobic step comprises exposing the vanilla bean pieces to air.

8. A process according to claim 1, wherein the incubation step iv) is conducted at between 20 and 60° C.

9. A process according to claim 1, wherein the incubation step iv) is conducted at a relative humidity of between 50 and 90%.

10. A process according to claim 1, wherein the incubation step iv) is conducted for a length of time such that the level of vanillin in the bean pieces is maximized.

11. A process according to claim 1, wherein the drying step v) is conducted at 40 to 100° C.

12. A process according to claim 1, wherein the drying step v) is conducted for a length of time such that the bean pieces have a water content of below 30%.

13. A process according to claim 1, wherein the progress of incubation step iv) is monitored so that the content of products including vanillin is optimised.

14. A process according to claim 13, wherein the ratio of vanillin to glucovanillin is monitored.

15. A process according to claim 13, wherein the content of products formed by the breakdown of vanillin is monitored.

16. A process according to claim 13, wherein the content of polyphenols formed by the breakdown of vanillin is monitored.

17. A process according to claim 1, comprising a further step of extracting the vanilla bean pieces with a solvent to provide a vanilla extract.

18. A process according to claim 17, comprising a further step of concentrating the vanilla extract.

19. A process according to claim 1, wherein:
the vanilla beans are blanched in water at a temperature and for a time sufficient to kill fungal organisms while not affecting its enzyme system that is necessary for fermentation;
step is present and the blanched beans are cooled by treatment with water at a temperature below ambient;
the beans are comminuted into pieces having an average size of between 0.5 and 1 cm in length to provide an optimum surface area for exposure in the incubating step; and
the bean pieces are incubated at a temperature of between 30 and 50° C. and at about 60 to 80% relative humidity first under anaerobic conditions including exposure to an atmosphere having with an oxygen content of less than 10% to convert glucovanillin to vanillin, followed by aerobic conditions including exposure to an atmosphere that contains a controlled amount of air to convert the vanillin and functionalized phenols to brown pigments.

20. A process according to claim 19, comprising the further steps of extracting the vanilla bean pieces with a solvent to provide a vanilla extract and concentrating the vanilla extract.
